(19) United States
(12) Patent Application Publication
(10) Pub. No.: US 2004/0204534 A1
(43) Pub. Date: Oct. 14, 2004

(54) Method of improving dispersion during a plastic compounding process by use of a particulate polymer

(76) Inventor: Jeffrey S. Borke, Middletown, OH (US)

Correspondence Address: BROOKS KUSHMAN P.C., 1000 TOWN CENTER, TWENTY-SECOND FLOOR, SOUTHFIELD, MI, 48075, US

(21) Appl. No.: 10/410,112

(22) Filed: Apr. 9, 2003

(51) Int. Cl. C08L 1/00

(52) U.S. Cl. 524/515

(57) ABSTRACT

The present invention discloses, a method of compounding a polymer such that any additives added to the polymer are well dispersed. The method of the invention comprises providing a polymer premixture that includes a powder source of a first thermoplastic polymer, at least one polymer additive, and a bulk source of a second thermoplastic polymer, and mixing the polymer premixture to form a polymer mixture. The bulk source of the second thermoplastic polymer is characterized as having a particle size that is at least 10 times greater than the particle size in the powder. Moreover, the amount of the powder source used in this method is greater than about 1% of the total weight of the polymer premixture. The present invention further discloses a polymer premixture suitable for use in the method of the invention.

### BACKGROUND OF THE INVENTION

1. Field of the Invention

In at least one aspect, the present invention relates to methods of compounding plastic polymers with improved dispersion, and in particular, to methods of compounding thermoplastic polymers wherein additives are better dispersion with the polymer matrix.

2. Background Art

Thermoplastic polymers are polymers that melt or flow when heated. Typically such polymers are not highly cross linked. Representative thermoplastic polymers include polyolefin-based polymers, polystyrene-based polymers, polycarbonate polymers, a polyamide polymers, and the like. Polyolefins include such polymers as polyethylene homopolymers, polyethylene copolymers, polypropylene homopolymers, and polypropylene copolymers. Polyethylene is among the most widely utilized plastics in the world.

Polyethylene is available in numerous forms required of the various and distinct end uses for which it is destined. Polyethylene may be roughly-divided into low density and high density grades. Low density polyethylene (“LDPE”) is characterized as being branched while high density polyethylene (“HDPE”) is predominately unbranched (i.e., linear). Within each grade, polyethylene may exhibit a variety of melt temperatures, melt flow ratios, melt viscosities, and the like. The physical properties of each type of polyethylene must be closely tailored to the specific end use, otherwise processing becomes problematic or even impossible. Thus, it is impossible, in general, to employ a polyethylene composition tailored for one type of processing in another type of processing. For example, low density polyethylene (LDPE) is widely used for preparation of films, and finds uses in such items as cargo wrap and plastic refuse bags. LDPE is relatively easy to formulate for such uses, and may contain numerous ingredients in addition to LDPE itself, i.e., pigments, UV absorbers, thermal stabilizers, plasticizers, lubricants, etc.

Thermoplastic polymers, and in particular polyolefin polymers, are typically compounded and blended with various additives. Such additives include, for example, UV stabilizers, flame retardants, fillers, and pigments. Moreover, compounding is often accomplished with a banbury mixer or in an extruder. Although, such process work well for the most part, the various mixing and blending processes tend to produce polymers in which the additives tend to agglomerate. Agglomeration is undesirable because it often causes blemishes in the plastic and also results in inefficient utilization of the additives.

Accordingly, there exists a need for an improved process for dispersing additives in a thermoplastic polymer during compounding and blending.

### SUMMARY OF THE INVENTION

The present invention overcomes the problems encountered in the prior art by providing in one embodiment a method of compounding thermoplastic polymers with one or more additives. The method comprises providing a polymer premixture comprising a powder source of a first thermoplastic polymer, at least one polymer additive, and a bulk source of a second thermoplastic polymer, and mixing the polymer premixture to form a polymer mixture. The bulk source of the second thermoplastic polymer is characterized as having a particle size that is at least 10 times greater than the particle size in the powder. Moreover, the amount of the powder source used in this method is greater than about 1% of the total weight of the polymer premixture.

In another embodiment of the present invention, a polymer premixture to be used in the method set forth above is provided. This polymer premixture comprises a powder source of a first thermoplastic polymer, at least one polymer additive, and a bulk source of a second thermoplastic polymer. As set forth above in the method of the invention, the bulk source of the second thermoplastic polymer is characterized as having a particle size that is at least 10 times greater than the particle size in the powder and the amount of the powder source is greater than about 1% of the total weight of the polymer premixture.

### DETAILED DESCRIPTION OF THE PREFERRED EMBODIMENT(S)

In one embodiment of the present invention, a method of compounding a polymer so that additives are efficiently dispersed is provided. This polymer compounding method comprises:

providing a polymer premixture comprising:

a powder source of a first thermoplastic polymer having a powder particle size from about 1 micron to about 1500 microns;

at least one polymer additive; and

a bulk source of a second thermoplastic polymer wherein the bulk source has a bulk source particle size that is at least 10 times greater than the powder particle size;

mixing the polymer premixture to form a polymer mixture, wherein the amount of the powder source is greater than about 1% of the total weight of the polymer premixture. The polymer premixture is prepared by simply combining each of the components together. Moreover, the bulk source of the thermoplastic polymer is characterized as having particles that are much larger than the particles in the powder source. More preferably, the powder source has a powder particle size from about 1 micron to about 100 microns, and most preferably, the powder source has a powder particle size from about 1 micron to about 1500 microns. Typically, the bulk source of the thermoplastic comprises polymer pellets. Plastic pellets of a few millimeters in length are often used in conventional compounding processes.

In order to induce improved dispersion of any additives introduced into the polymer premixture, the amount of powder source is greater than about 1% by weight of the total weight of the polymer premixture. More preferably, the powder source is greater than about 5% of the total weight of the polymer premixture, and most preferably the powder source is greater than about 10% of the total weight of the polymer premixture. Preferably, the amount of powder in the polymer premixture is from about 1% to about 20% of the total weight of the polymer premixture. More preferably, the amount of powder is from about 5% to about 15% of the total weight of the polymer premixture, and most preferably, the amount of the powder source is about 10% of the total weight of the polymer premixture.

The step of mixing in the method of the present invention preferably comprises mechanically stirring the polymer pre-mixture. This mixing may be used to form a polymer mixture to be subsequently used in a plastic molding process. Suitable mixing equipment includes banbury mixers, twin-screw rotary mixer, buss kneader, and plastic extruders. In addition, the step of mixing may be integrally included into a molding process since most molding equipment utilizes worn screws that mix polymer during molding. Such molding equipment includes, but is not limited to, injection molding equipment, compression molding equipment, and blow molding equipment.

The first and second thermoplastic polymer used in the method of the present invention may be any thermoplastic polymer. Suitable thermoplastic polymers include, but are not limited to, a polyolefin-based polymer, a polystyrene-based polymer, a polycarbonate polymer, or mixture thereof. More preferably, the thermoplastic polymer is a polyethylene homopolymer, a polyethylene copolymer, a polypropylene homopolymer, or a polypropylene copolymer, and most preferably, the thermoplastic polymer is a polypropylene homopolymer. Although the first and second thermoplastic polymer may be different thermoplastic polymer, in a particularly preferred embodiment, the first and second thermoplastic polymer will be the same thermoplastic polymer.

At least one additive is compounded along with the thermoplastic pellets and powder in the method of the present invention. Suitable additives include, but are not limited to UV stabilizers, flame retardants, fillers, and pigments. Additives are important in establishing the long term stability of the polymer as well as chemical and impact resistance. Specifically, the polymer mixture formed by the method of the present invention optionally includes UV stabilizers preferably present in an amount from about 1500 ppm to about 2500 ppm. More preferably the UV stabilizers are present in an amount of 1750 ppm to about 2250 ppm, and most preferably, the UV stabilizers are present in an amount of about 2000 ppm. Suitable UV stabilizers include, but are not limited to hindered amine light stabilizers (“HALS”). Examples of HALS include: Chimassorb 944, Chimassorb 994, Chimassorb 905, Tinuvin 770, Tinuvin 992, Tinuvin 622, Tinuvin 144, and Spinuvex A36 available from Geigy; and Cyasorb UV 3346 and Cyasorb UV 944 commercially available American Cyanamide. Particularly preferred UV stabilizers are Cytec UV 3346 and Chemasorb 944 (poly[N,N-bis(2,2,6,6-tetramethyl-4-piperidinyl)-1,6-hexanediamine-co-2,4-dichloro-6-morpholino-1,3,5-triazine.) Flame retardants include, for example, halogen-containing compounds, antimony oxides, phosphorus compounds, aluminum trihydrate, antimony oxide (Sb₂O₃), magnesium hydroxide, and decabromobiphenyl oxide (“decabrome”). Preferably, flame retardants are present in an amount of about 1% to 70% of the weight of polymer mixture. Suitable fillers include, but are not limited to, fiberglass, long glass fibers, carbon fiber, and talc. These fillers allow the material properties of the polymer to be adjusted. Preferably, these fillers are present in an amount of about 1% to 70% of the weight of polymer mixture.

In another embodiment of the present invention, a polymer premixture that is used in the method set forth above is provided. The polymer premixture comprises:

a powder source of a first thermoplastic polymer having a powder particle size from about 1 micron to about 1000 microns;

at least one polymer additive; and

a bulk source of a second thermoplastic polymer wherein the bulk source has a bulk particle size that is at least 10 times greater than the powder particle size;

wherein the amount of the powder source is greater than about 1% of the total weight of the polymer premixture. The characteristics of the powder source, additives, and the bulk source are the same as set forth above.

The following examples illustrate the various embodiments of the present invention. Those skilled in the art will recognize many variations that are within the spirit of the present invention and scope of the claims.

### EXAMPLE 1

A polymer premixture is formed by combining 99% by weight High Density Polyethylene (“HDPE”) pellets and 1% by weight azodicarbonamide. The premixture is then compounded in a banbury mixer. The resulting polymer mixture produced a polymer tape that had over 100 undispersed agglomerates per foot.

### EXAMPLE 2

A polymer premixture is formed by combining 89% by weight HDPE pellets, 10% by weight HDPE powder, and 1% by weight azodicarbonamide. The premixture is then compounded in a banbury mixer. The resulting polymer mixture produced a polymer tape that had about 1 undispersed agglomerate per foot.

### EXAMPLE 3

A polymer premixture is formed by combining 99% by weight HDPE powder and 1% by weight azodicarbonamide. The premixture is then compounded in a banbury mixer. The resulting polymer mixture produced a polymer tape that had about 2 undispersed agglomerates per foot.

### EXAMPLE 4

A polymer premixture is formed by combining 75% by weight HDPE pellets and 25% decabromodiphenyl oxide. The premixture is then compounded in a banbury mixer. The resulting polymer mixture produced a polymer tape that had over 100 undispersed agglomerates per foot.

### EXAMPLE 5

A polymer premixture is formed by combining 67.5% by weight HDPE pellets, 7.5% HDPE powder, and 25% decabromodiphenyl oxide. The premixture is then compounded in a banbury mixer. The resulting polymer mixture produced a polymer tape that had about 4 undispersed agglomerates per foot.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of compounding a polymer, the method comprising:
providing a polymer premixture including:
a powder source of a thermoplastic polymer having a powder particle size from about 1 micron to about 1000 microns;
at least one polymer additive; and
a bulk source of the thermoplastic polymer wherein the bulk source of the thermoplastic polymer has a bulk particle size that is at least 10 times greater than the powder particle size;
mixing the polymer premixture to form a polymer mixture, wherein the amount of the powder source is greater than about 1% of the total weight of the polymer premixture.

2. The method of claim 1 wherein the bulk source of the thermoplastic comprises polymer pellets.

3. The method of claim 1 wherein the amount of the powder source is greater than about 5% of the total weight of the polymer premixture.

4. The method of claim 1 wherein the amount of the powder source is greater than about 10% of the total weight of the polymer premixture.

5. The method of claim 1 wherein the amount of the powder source is from about 1% to about 20% of the total weight of the polymer premixture.

6. The method of claim 1 wherein the amount of the powder source is from about 5% to about 15% of the total weight of the polymer premixture.

7. The method of claim 1 wherein the amount of the powder source is about 10% of the total weight of the polymer premixture.

8. The method of claim 1 wherein the step of mixing the polymer premixture is by mechanical stirring.

9. The method of claim 1 wherein the step of mixing the polymer premixture occurs in a plastic extruder, twin-screw rotary mixer, buss kneader, injection molding equipment, compression molding equipment, blow molding equipment, or a banbury mixer.

10. The method of claim 1 wherein the thermoplastic polymer is a polyolefin-based polymer, a polystyrene-based polymer, a polycarbonate polymer, or mixture thereof.

11. The method of claim 1, wherein a thermoplastic polymer is a polyethylene homopolymer, a polyethylene copolymer, a polypropylene homopolymer, or a polypropylene copolymer.

12. The method of claim 1 wherein a thermoplastic polymer is a polypropylene homopolymer.

13. The method of claim 1 wherein the at least one polymer additive is selected from the group consisting of UV stabilizers, flame retardants, fillers, pigments, and mixtures thereof.

14. A polymer premixture comprising:
a powder source of a thermoplastic polymer having a powder particle size from about 1 micron to about 1000 microns;
at least one polymer additive; and
a bulk source of the thermoplastic polymer wherein the bulk source of the thermoplastic polymer has a bulk particle size that is at least 10 times greater than the powder particle size wherein the amount of the powder source is greater than about 1% of the total weight of the polymer premixture.

15. The polymer premixture of claim 14 wherein the bulk source of the thermoplastic comprises polymer pellets.

16. The polymer premixture of claim 14 wherein the amount of the powder source is greater than about 5% of the total weight of the polymer premixture.

17. The polymer premixture of claim 14 wherein the amount of the powder source is greater than about 10% of the total weight of the polymer premixture.

18. The polymer premixture of claim 14 wherein the amount of the powder source is from about 1% to about 20% of the total weight of the polymer premixture.

19. The polymer premixture of claim 14 wherein the amount of the powder source is from about 5% to about 15% of the total weight of the polymer premixture.

20. The polymer premixture of claim 14 wherein the amount of the powder source is about 10% of the total weight of the polymer premixture.

21. The polymer premixture of claim 14 wherein the thermoplastic polymer is a polyolefin-based polymer, a polystyrene-based polymer, a polycarbonate polymer, or mixture thereof.

22. The polymer premixture of claim 14 wherein a thermoplastic polymer is a polyethylene homopolymer, a polyethylene copolymer, a polypropylene homopolymer, or a polypropylene copolymer.

23. The polymer premixture of claim 14 wherein a thermoplastic polymer is a polypropylene homopolymer.

24. The polymer premixture of claim 14 wherein the at least one polymer additive is selected from the group consisting of UV stabilizers, flame retardants, fillers, pigments, and mixtures thereof.
